(19) United States
(12) Patent Application Publication
(10) Pub. No.: US 2024/0013242 A1
(43) Pub. Date: Jan. 11, 2024

(54) ANALYSIS DEVICE, ANALYSIS METHOD, AND RECORDING MEDIUM

(71) Applicant: NEC Corporation, Minato-ku, Tokyo (JP)

(72) Inventors: Satoshi Sakaribara, Tokyo (JP); Yusuke Iwasaki, Tokyo (JP); Akio Kawachi, Tokyo (JP); Yuya Hanzawa, Tokyo (JP); Xiaoyu Song, Tokyo (JP)

(73) Assignee: NEC Corporation, Minato-ku, Tokyo (JP)

(21) Appl. No.: 18/021,626

(22) PCT Filed: Sep. 28, 2020
(86) PCT No.: PCT/JP2020/036626

§ 371 Date: Feb. 16, 2023

(51) Int. Cl. G06Q 30/0204; G06Q 50/16

(52) U.S. Cl. CPC G06Q 30/0204; G06Q 50/16

(57) ABSTRACT

This analysis device comprises: a relationship analysis unit that uses customer segment data including a customer segment indicating the classification of a customer and renovation record data indicating the history of past renovation works to analyze a temporal order relationship between at least two renovation works based on renovation work dates of each customer for each customer segment; and an output unit that outputs an analysis result.

### TECHNICAL FIELD

The present disclosure relates to an analysis device and the like for supporting renovation sales.

### BACKGROUND ART

Various renovation works are executed in the housing life cycle. PTL 1 describes a technique of proposing renovation according to the elapsed years based on a replacement cycle of components or a main body of a facility.

### CITATION LIST

### Patent Literature

[PTL 1] JP 2004-310783 A

### SUMMARY OF INVENTION

### Technical Problem

However, the content, the number of times, the period, and the like of renovation work to be executed vary depending on the customer due to various factors such as a house price or a use situation. For this reason, in renovation sales, it is important to grasp the purchase tendency of the customer in advance and propose an appropriate product.

One of the objects of the present disclosure is to provide an analysis device and the like that can grasp a purchase tendency of a customer.

### Solution to Problem

An analysis device that is a first aspect of the present disclosure includes: a relationship analysis unit that, based on customer segment data including customer segments indicating the classification of customers and renovation record data indicating the history of past renovation works, analyzes a time-series relationship between at least two renovation works based on renovation work dates for each of the customers for each of the customer segments; and an output unit that outputs an analysis result.

An analysis method that is a second aspect of the present disclosure includes: based on customer segment data including customer segments indicating the classification of customers and renovation record data indicating the history of past renovation works, analyzing a time-series relationship between at least two renovation works based on renovation work dates for each of the customers for each of the customer segments; and outputting an analysis result.

An analysis program that is a third aspect of the present disclosure causes a computer to execute: based on customer segment data including customer segments indicating the classification of customers and renovation record data indicating the history of past renovation works, analyzing a time-series relationship between at least two renovation works based on renovation work dates for each of the customers for each of the customer segments; and outputting an analysis result.

The analysis program may be stored in a non-transitory computer-readable/writable recording medium.

### Advantageous Effects of Invention

According to the analysis device and the like of the present disclosure, it is possible to grasp a purchase tendency of a customer.

### BRIEF DESCRIPTION OF DRAWINGS

FIG. 1 is a block diagram illustrating a configuration example of an analysis system according to a first example embodiment.

FIG. 2 is a block diagram illustrating a configuration example of a database according to the first example embodiment.

FIG. 3 is a view illustrating an example of house and customer data stored in the database.

FIG. 4 is a view illustrating an example of customer segment data stored in the database.

FIG. 5 is a view illustrating an example of the type of customer segments.

FIG. 6 is a view illustrating another example of the type of customer segments.

FIG. 7 is a view illustrating an example of renovation record data stored in the database.

FIG. 8 is a block diagram illustrating a configuration example of an analysis device according to the first example embodiment.

FIG. 9 is a view illustrating an example of renovation history information of each of the customers in a customer segment A.

FIG. 10 is a view illustrating an example of data of a work group type.

FIG. 11 is a view illustrating an example of a time-series relationship of renovation work for each of the customers.

FIG. 12 is a view illustrating an example of analysis results in customer segments A and B.

FIG. 13 is a flowchart illustrating an example of the operation of the analysis device according to the first example embodiment.

FIG. 14 is a flowchart illustrating an example of processing in step S11.

FIG. 15 is a block diagram illustrating an example of a hardware configuration of a computer.

### EXAMPLE EMBODIMENT

### First Example Embodiment

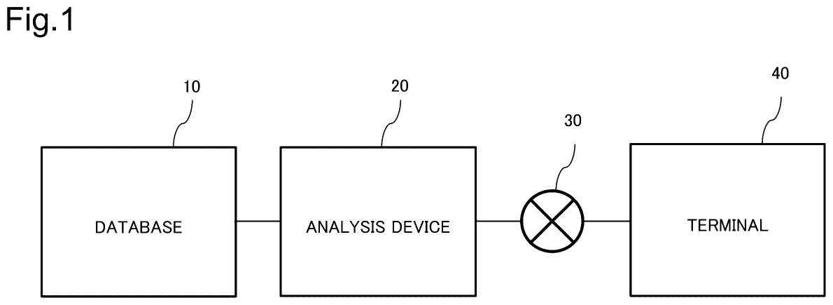

An analysis system of the first example embodiment will be described with reference to the drawings. FIG. 1 is a block diagram illustrating an example of the configuration of the analysis system according to the first example embodiment. The analysis system illustrated in FIG. 1 includes a database 10, an analysis device 20, a network 30, and a terminal 40. An example of the database 10 includes a memory or storage. The analysis device 20 and the terminal 40 each include, for example, a computer.

(Database)

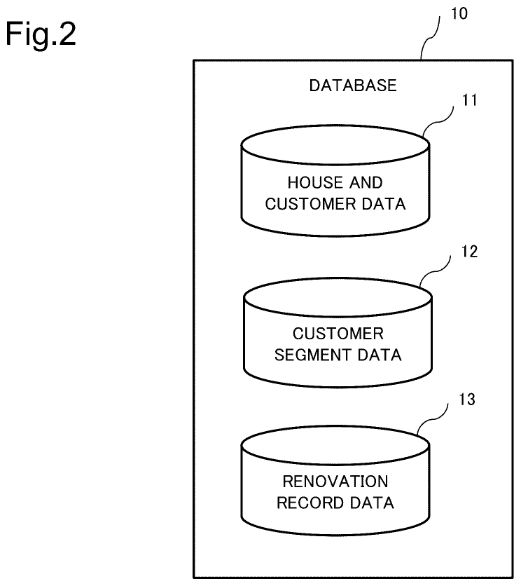

The database 10 according to the first example embodiment will be described with reference to the drawings. FIG. 2 is a block diagram illustrating a configuration example of the database 10 according to the first example embodiment. The database 10 illustrated in FIG. 2 stores house and customer data 11, customer segment data 12, and renovation record data 13.

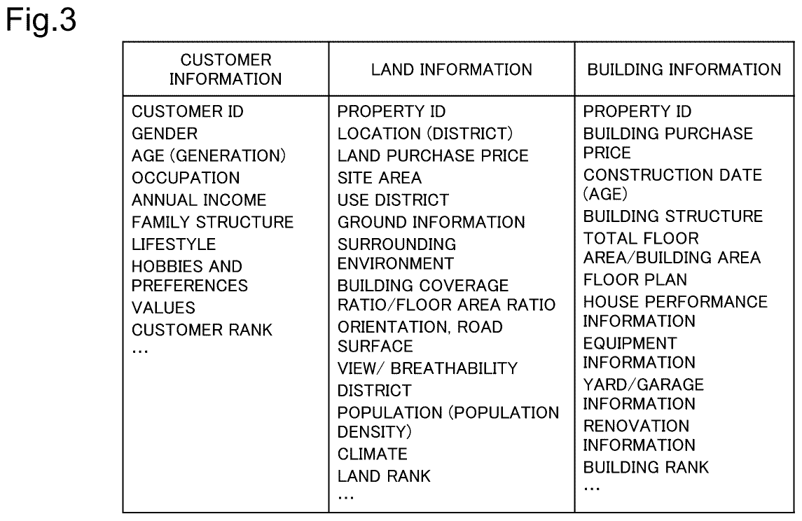

The house and customer data 11 is data of attribute information regarding a customer and a house of the customer. FIG. 3 is a view illustrating an example of the house and customer data 11 stored in the database 10. The house and customer data 11 illustrated in FIG. 3 includes customer information, land information, and building information. The customer information is information indicating the attribute of the customer, and includes data having items of, for example, customer ID, gender, age, address, occupation, annual income, family structure, land ownership information, property purchase history, customer rank, loan balance, and posting history to a social networking service (SNS).

The land information is information indicating the attribute of the land, and includes data having items such as, for example, location, area, use district, ground information, surrounding environment, building coverage ratio/floor area ratio, orientation, road surface, and view/breathability. The surrounding environment is information on facilities related to life around the house. The facilities include, for example, commercial facilities, medical facilities, schools, and parks.

The building information is information indicating the attribute of the building, and includes data having items of, for example, work date (age), building structure, total floor area/building area, floor plan, house performance information, equipment information, yard/garage information, renovation information, and defect (physical, legal, and psychological). The renovation information includes a business meeting ID, a business meeting date, a contract date, a product ID, a work type, a work group type, a construction work cost, and a business contact ID. The work type may be, for example, a work name such as interior or exterior of the building, or an equipment name of a bath, a toilet, or a kitchen.

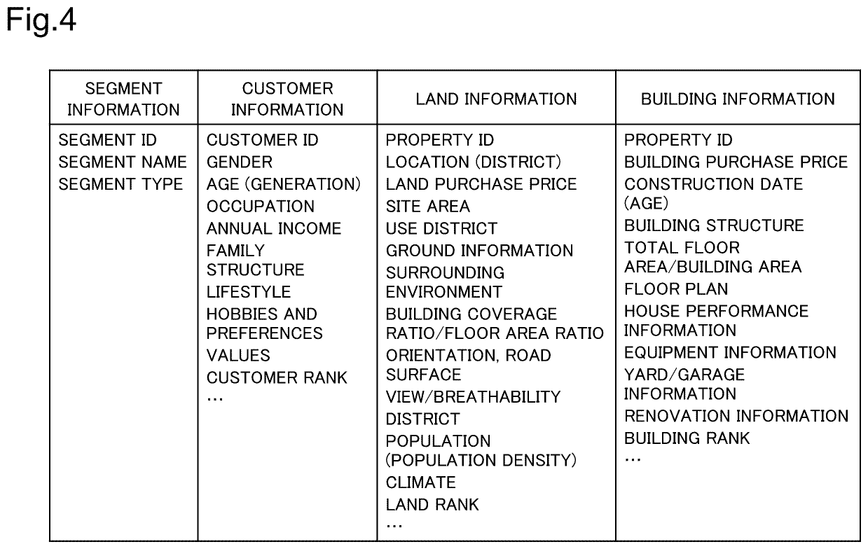

The customer segment data 12 is data indicating a customer group divided by a certain criterion. FIG. 4 is a view illustrating an example of the customer segment data 12 stored in the database 10. The customer segment data illustrated in FIG. 4 includes segment information, customer information, land information, and building information. The segment information is information indicating the attribute of a segment, and includes data having items of a segment ID, a segment name, a segment type, and the like. The segment type represents a criterion for division into segments. The customer information, the land information, and the building information of FIG. 4 may include data of items similar to those of the customer information, the land information, and the building information of FIG. 3.

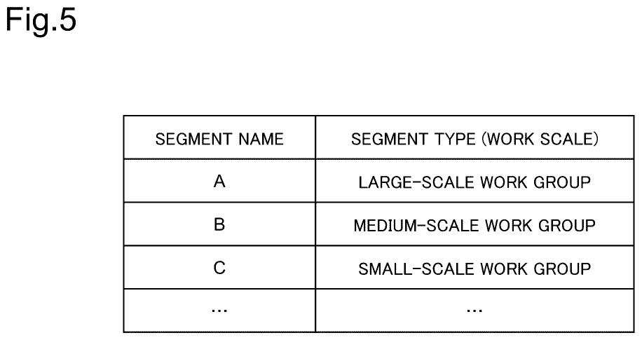

FIG. 5 is a view illustrating an example of the type of customer segments. FIG. 5 illustrates an example in which the customer segment (in the figure, referred to as segment type) is divided by the work scale of renovation executed for new buildings. In the figure, “large-scale work group”, “medium-scale work group”, and “small-scale work group” of the segment type are associated with the segment names “A”, “B”, and “C”. The work scale is not limited to the example of FIG. 5, and may be divided by the range of the work cost (construction work cost) of the renovation, for example. Three or more segment types may be used.

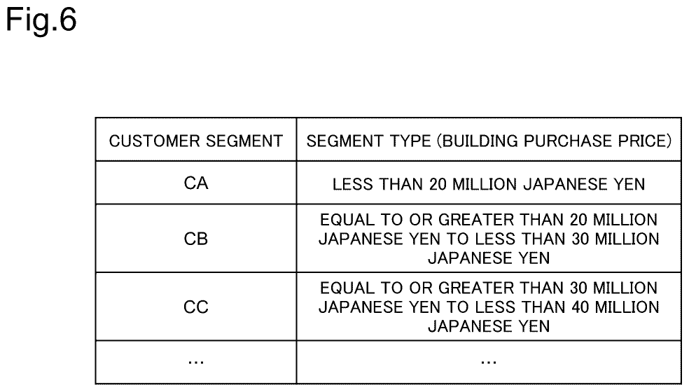

FIG. 6 is a view illustrating another example of the type of customer segments. FIG. 6 illustrates an example in which the customer segment (in the figure, referred to as segment type) is divided by the house purchase price of the customer. In the figure, “less than 20 million Japanese Yen”, “equal to or more than 20 million Japanese Yen and less than 30 million Japanese Yen”, and “equal to or more than 30 million Japanese Yen and less than 40 million Japanese Yen” of the segment type are associated with the segment names “CA”, “CB”, and “CC”. The type of the customer segment is not limited to the above, and various criteria can be set.

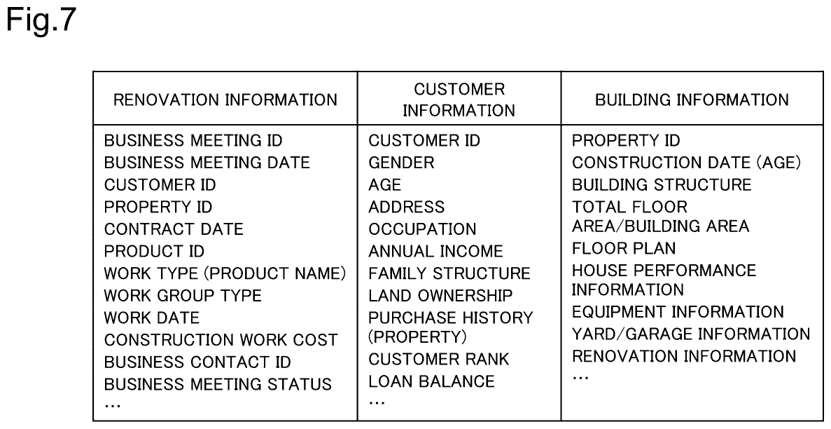

FIG. 7 is a view illustrating an example of the renovation record data 13 stored in the database 10. The renovation record data 13 is data indicating record data of past renovation works. The renovation record data 13 illustrated in FIG. 7 includes renovation information, customer information, and building information. The renovation record data 13 may include other information in addition to the renovation information, the customer information, and the building information. The renovation information is information indicating the attribute of the renovation work. The renovation information includes data having items of, for example, business meeting ID, business meeting date, customer ID, property ID, contract date, product ID, work type, work group type, work date, construction work cost, business contact ID, or business meeting status. The business meeting status is the history of renovation work proposed to the customer. The history includes not only records but also proposals and missing order statuses. The renovation information is not limited to the above example. The customer information and the building information of FIG. 5 may include data of items similar to those of the customer information and the building information of FIG. 3.

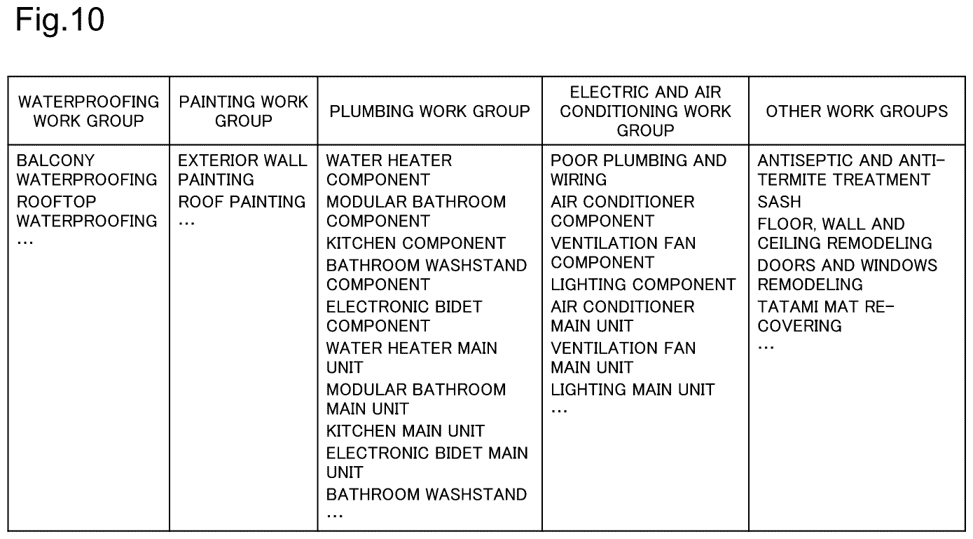

FIG. 10 is a view illustrating a data example of the work group type. As illustrated in FIG. 10, the work group type includes data having items of waterproofing work group, painting work group, plumbing work group, electric and air conditioning work group, and other work groups. The items of the work group type illustrated in FIG. 10 are examples, and the present invention is not limited to them.

(Analysis Device)

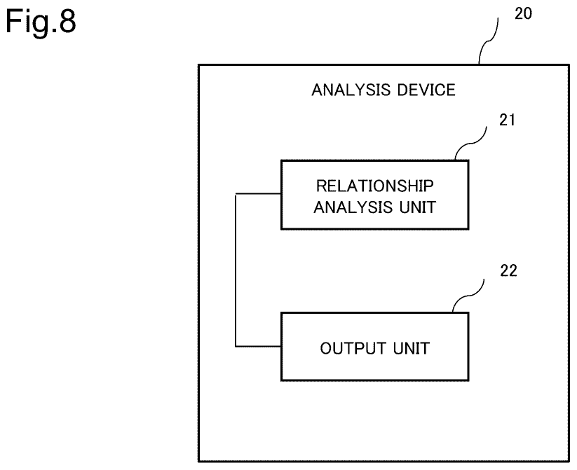

Next, the analysis device 20 of the first example embodiment will be described with reference to the drawings. FIG. 8 is a block diagram illustrating a configuration example of the analysis device 20 according to the first example embodiment. The analysis device 20 illustrated in FIG. 8 includes a relationship analysis unit 21 and an output unit 22.

In FIG. 8, the relationship analysis unit 21 acquires the customer segment data 12 and the renovation record data 13 from the database 10. The relationship analysis unit 21 generates renovation history information of each customer for each customer segment based on the customer segment data 12 and the renovation record data 13.

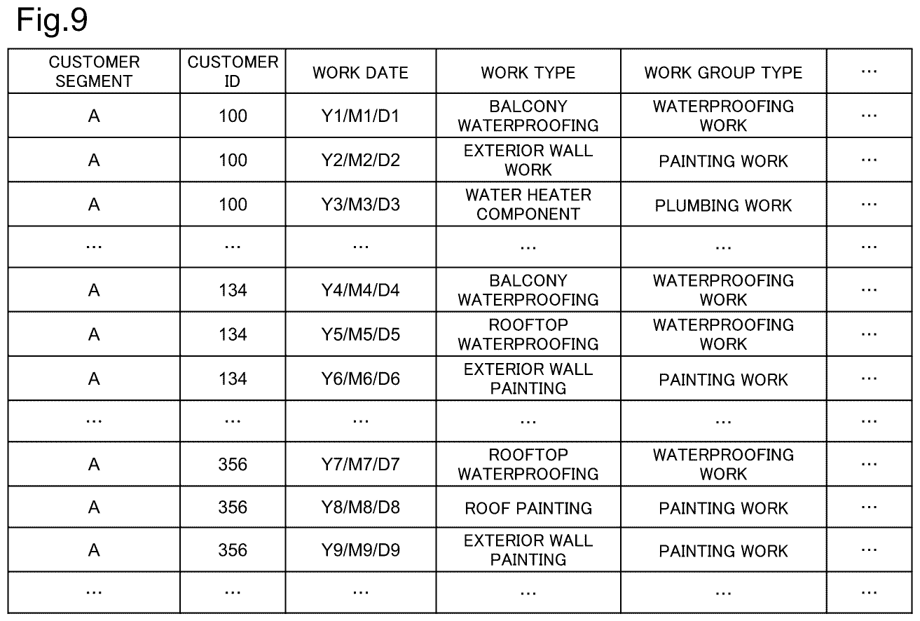

FIG. 9 is a view illustrating the renovation history information of each customer in the customer segment A. The renovation history information illustrated in FIG. 9 is data having items of customer segment, customer ID, work date, work type, and work group type. The work date is a date when the renovation work is executed. The work type is information indicating the attribute of the renovation work. The work group type is information indicating the classified group of the renovation work. The items of the renovation history information illustrated in FIG. 9 are examples, and the present invention is not limited to them.

The relationship analysis unit 21 analyzes the time-series relationship of the renovation work of each customer in the customer segment A using generated renovation history information. The time-series relationship of the renovation work indicates a chronological relationship of at least two renovation works based on renovation work date. For example, the relationship analysis unit 21 arranges renovation works in order of execution of the works for each customer, and extracts the renovation works having a strong time-series relationship of renovation works in the customer segment A.

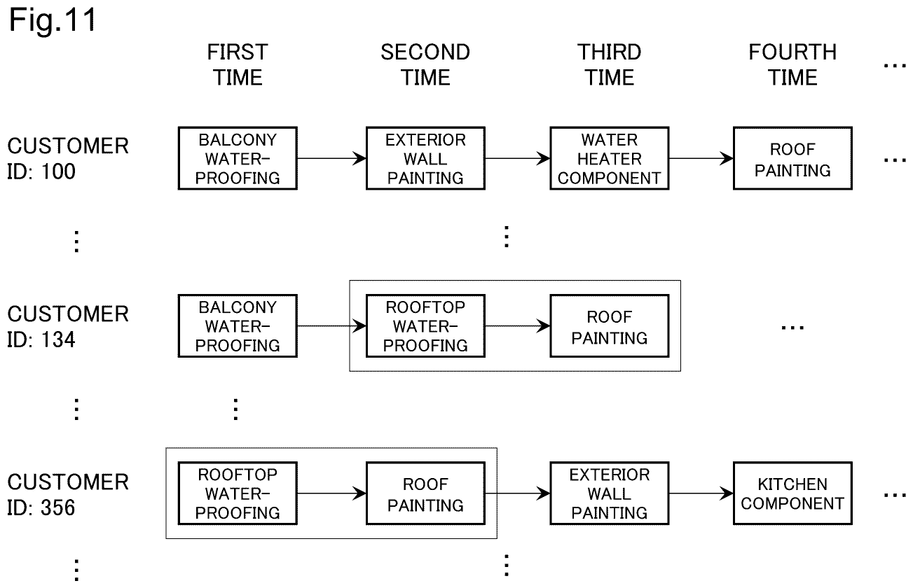

FIG. 11 is a view illustrating an example of a time-series relationship of renovation work for each customer in the customer segment. In FIG. 11, in the second and third renovation works for the customer ID “134” and the first and second renovation works for the customer ID “356”, “roof painting” is executed after “roof waterproofing”. In this manner, the relationship analysis unit 21 can obtain the strength of the time-series relationship of renovation works by counting the number of times of execution of renovation works indicated by the same time-series relationship within the same customer segment in renovation history information. For example, the relationship analysis unit 21 adopts, as an analysis result, a work name having the largest number of times of execution of renovation works indicated by the same time-series relationship in a certain customer segment. Specifically, in the time-series relationship of the renovation works for each customer in the customer segment illustrated in FIG. 11, in a case where the number of times of execution of “roof painting” is the largest next to “roof waterproofing” indicating the time-series relationship of the same renovation work, “roof waterproofing→roof painting” is adopted as the analysis result.

In the above description, an example of the time-series relationship between two renovation works has been described, but the present invention is not limited to this. For example, the relationship analysis unit 21 may obtain the strength of the time-series relationship of three renovation works. The relationship analysis unit 21 may obtain the strength of the time-series relationship of not only renovation works but also renovation work groups. For example, the relationship analysis unit 21 may count the number of times of execution of the time-series relationship of the same renovation work group in the time-series relationship of the renovation work groups for each customer in the customer segment. For example, in a case where the number of times of execution of “painting work group” is the largest next to “waterproofing work group” that is the time-series relationship of the same renovation work group, the relationship analysis unit 21 adopts “waterproofing work group→painting work group” as the analysis result.

Furthermore, the index of the strength of the time-series relationship of renovation works may be an execution ratio or an execution rate in addition to the number of times of execution of the time-series relationship of the renovation works.

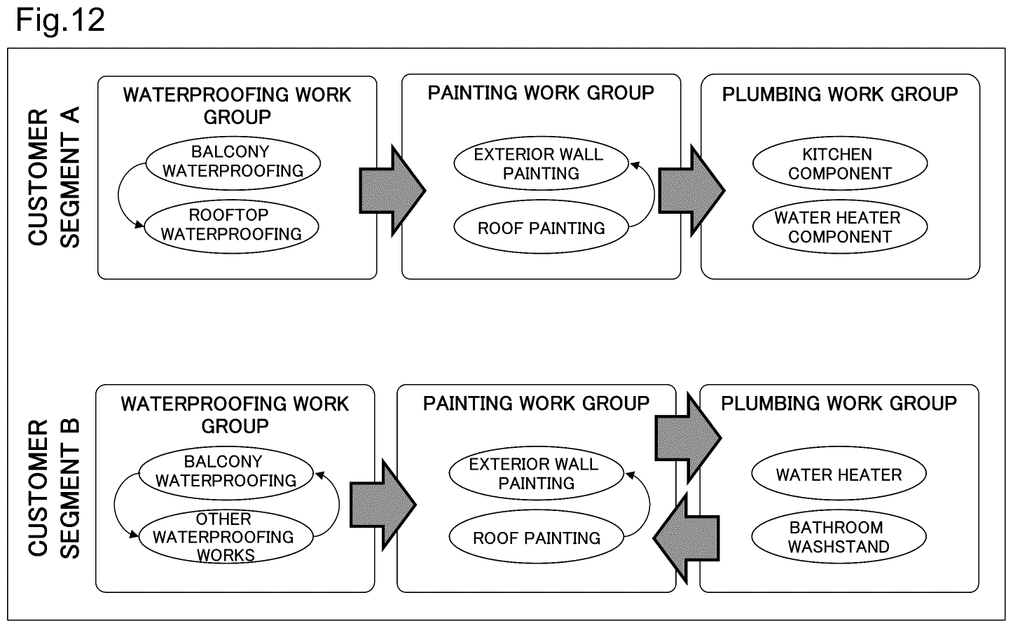

As a result of the analysis, the relationship analysis unit 21 may generate, as visualization information of the renovation work, the time-series relationship of the renovation work or the renovation work group with a large number of times of execution. FIG. 12 is a view illustrating an example of analysis results in the customer segments A and B.

FIG. 12 can be also deemed to be information with visualized purchase tendency of the customers included in each of the customer segments A and B. The example of the customer segments A and B illustrated in FIG. 12 gives the result that there is a strong tendency that the group work in one direction is executed in the order of “waterproofing work group”, “painting work group”, and “plumbing work group” among the work groups. This indicates that, for example, the numbers of times of execution of “waterproofing work group→painting work group” and “painting work group→plumbing work group” are large among the work groups. It is concluded that in the waterproofing work group, there is a tendency that “rooftop waterproofing work” is executed after “balcony waterproofing work”, and that in the painting work group, there is a tendency that “exterior wall painting work” is executed after “roof painting work”. This indicates that the number of times of execution of “balcony waterproofing work→rooftop waterproofing work” and the number of times of execution of “roof painting work→exterior wall painting work” in the painting work group are large.

It is concluded that in the customer segment B, the group work tends to be executed in both directions in “painting work group” and “plumbing work group”. This indicates that the numbers of times of execution of “painting work group→plumbing work group” and “plumbing work group→painting work group” are large. This result is deemed to indicate that it is possible to suggest, to the customer belonging to the customer segment B, the work of “outdoor painting work group” again next to the execution of the work of “plumbing work group”. Furthermore, it is concluded that there is a loop relationship between “balcony waterproofing work” and “other waterproofing works” in the waterproofing work group. It is deemed that there is a possibility that the customers of the customer segment B continuously order the renovation work for these works.

Upon ending the relationship analysis of the renovation works on the target customer segment, the relationship analysis unit 21 sends the analysis result to the output unit 22.

The output unit 22 outputs the analysis result of the renovation work or the renovation work group in the target customer segment. The larger the number of times of execution of the renovation work or the renovation work group indicating the time-series relationship of the renovation work group is, the higher the possibility that the customers included in each customer segment exhibit a similar purchase tendency becomes. The output unit 22 may display the analysis result or visualized information of the relationship analysis unit 21 onto a display unit (not illustrated) of the analysis device 20, or may transmit it to the terminal 40 illustrated in FIG. 1 via the network 30.

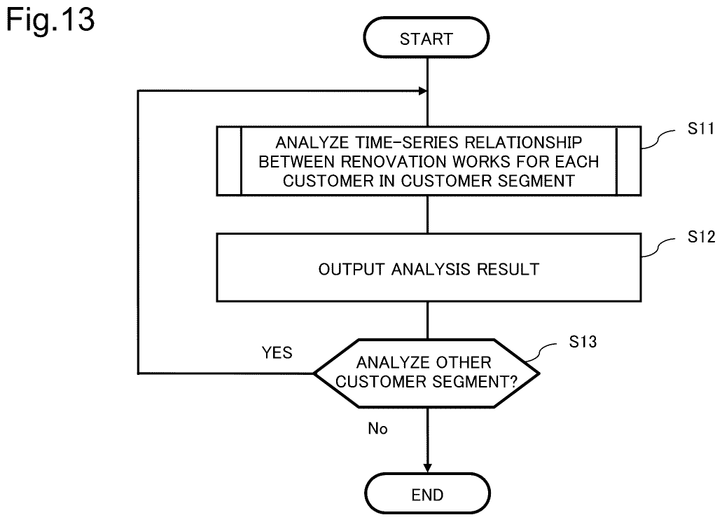

Next, the operation of the analysis device 20 of the first example embodiment will be described with reference to the drawings. FIG. 13 is a flowchart illustrating an example of the operation of the analysis device 20. The relationship analysis unit 21 analyzes the time-series relationship of renovation works of each customer for each customer segment based on the customer segment data indicating the classification of the customers and the renovation record data indicating the history of the past renovation works (step S11).

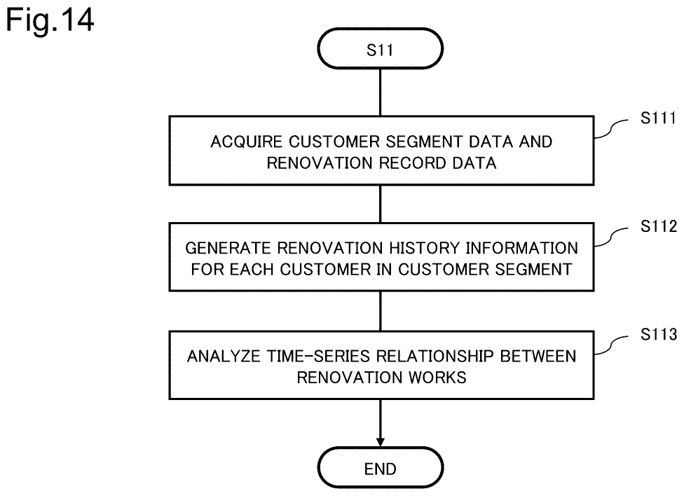

An example of the processing in step S11 will be described with reference to FIG. 14. As illustrated in FIG. 14, in step S11, the relationship analysis unit 21 acquires the customer segment data 12 and the renovation record data from the database 10 (step S111).

Furthermore, the relationship analysis unit 21 generates the renovation history information of each customer in the customer segment based on the customer segment data 12 and the renovation record data 13 (step S112). The relationship analysis unit 21 analyzes the time-series relationship of the renovation works of each customer in the customer segment A using the generated renovation history information (step S113). The relationship analysis unit 21 passes the analysis result to the output unit 22.

Returning to FIG. 13, the output unit 22 outputs the analysis result (step S12). When the time-series relationship of the renovation work of another customer segment is analyzed (Yes in step S13), the process proceeds to step S11. On the other hand, when another customer segment is not analyzed (No in step S13), the analysis device 20 ends the operation.

(Effects of First Example Embodiment)

According to the first example embodiment, the relationship analysis unit 21 analyzes the time-series relationship of at least two renovation works based on the renovation work date of each customer for each customer segment based on the customer segment data 12 including the customer segment indicating the classification of the customers and the renovation record data 13 indicating the history of the past renovation work. This makes it possible to grasp the purchase tendency of the customers in the customer segment.

(Hardware Configuration)

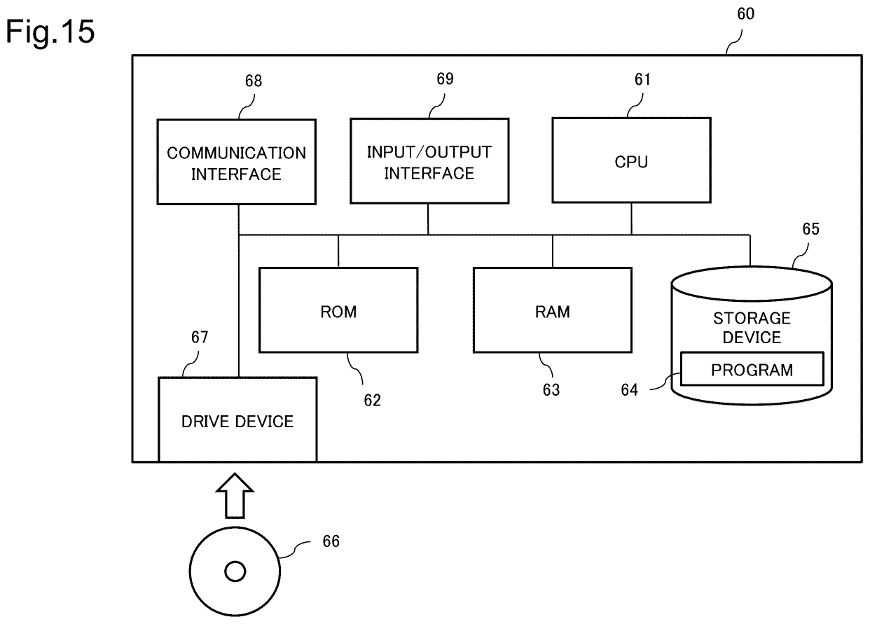

In the example embodiment, a part or all of each constituent element in the analysis device illustrated in FIG. 2 can also be implemented by using, for example, a discretionary combination of a computer 60 and a program illustrated in FIG. 15. As an example, the computer 60 includes the following configuration.
CPU 61
ROM 62
RAM 63
Storage device 65 storing program 64 and other data
Drive device 67 that reads and writes with recording medium 66
Communication interface 68
Input/output interface 69 for inputting/outputting data

Each constituent element of the analysis device in each example embodiment of the present application is implemented by the CPU 61 acquiring and executing the program 64 for implementing these functions. The program 64 for implementing the function of each constituent element of the analysis device is stored in the storage device 65 or the RAM 63 in advance, for example, and is read by the CPU 61 as necessary. The program 64 may be supplied to the CPU 61 via a communication network, or may be stored in advance in the recording medium 66, and the drive device 67 may read and supply, to the CPU 61, the program.

There are various modifications for the implementation method of each device. For example, the analysis device may be implemented by a discretionary combination of a separate information processing device and program for each constituent element. A plurality of constituent elements included in the analysis device may be implemented by a discretionary combination of one computer 60 and a program.

Some or all of the constituent elements of the analysis device are implemented by another general-purpose or dedicated circuit, a processor, and the like, or a combination of them. These may be configured by a single chip or may be configured by a plurality of chips connected via a bus.

Some or all of the constituent elements of the analysis device may be implemented by a combination of the above-described circuit and the like and a program.

In a case where some or all of the constituent elements of the analysis device are implemented by a plurality of information processing devices, circuits, and the like, the plurality of information processing devices, circuits, and the like may be arranged in a centralized manner or in a distributed manner. For example, the information processing devices, the circuits, and the like may be implemented as a form in which they are connected via a communication network such as a client and server system or a cloud computing system.

Although the invention of the present application has been described above with reference to the present example embodiment, the present invention is not limited to the above example embodiment. Various modifications that can be understood by those skilled in the art can be made to the configuration and details of the present invention within the scope of the present invention.

### REFERENCE SIGNS LIST

10 database
11 house and customer data
12 customer segment data
13 renovation record data
20 analysis device
21 relationship analysis unit
22 output unit

What is claimed is:

1. An analysis device comprising:
one or more memories storing instructions; and
one or more processors configured to execute the instructions to:
based on customer segment data including customer segments indicating a classification of customers and renovation record data indicating a history of past renovation works, analyze a time-series relationship of the renovation works based on renovation work dates for each of the customers for each of the customer segments, wherein the time-series relationship of the renovation works is time-series relationship between at least two renovation works; and
output an analysis result.

2. The analysis device according to claim 1, wherein the one or more processors configured to execute the instructions to:
generate renovation history information of each of the customers for each of the customer segments based on the customer segment data and the renovation record data.

3. The analysis device according to claim 2, wherein the one or more processors configured to execute the instructions to:
analyze a time-series relationship of the renovation works using the renovation history information of each of the customers.

4. The analysis device according to claim 1, wherein the one or more processors configured to execute the instructions to:
analyze a time-series relationship of renovation work groups indicating a classification of the renovation works.

5. The analysis device according to claim 1, wherein the one or more processors configured to execute the instructions to:
obtain, for each of the customer segments, an index of strength of the time-series relationship of the renovation works based on a number of times of execution, an execution ratio, or an execution rate between renovation works indicating the time-series relationship of the renovation works.

6. The analysis device according to claim 4, wherein the one or more processors configured to execute the instructions to:
obtain, for each of the customer segments, an index of strength of the time-series relationship of the renovation work groups based on the number of times of execution, an execution ratio, or an execution rate of the renovation work groups indicated by the time-series relationship of the renovation work groups.

7. The analysis device according to claim 5, wherein the one or more processors configured to execute the instructions to:
generate visualization information on the time-series relationship of the renovation works based on the index of strength of the time-series relationship of the renovation works.

8. The analysis device according to claim 6, wherein the one or more processors configured to execute the instructions to:
generate visualization information on the time-series relationship of the renovation work groups based on the index of strength of the time-series relationship of the renovation work groups.

9. An analysis method comprising:
based on customer segment data including customer segments indicating a classification of customers and renovation record data indicating a history of past renovation works, analyzing a time-series relationship of the renovation works based on renovation work dates for each of the customers for each of the customer segments, wherein the time-series relationship of the renovation works is time-series relationship between at least two renovation works; and
outputting an analysis result.

10. A recording medium that stores an analysis program that causes a computer to execute:
based on customer segment data including customer segments indicating a classification of customers and renovation record data indicating a history of past renovation works, analyzing a time-series relationship of the renovation works based on renovation work dates for each of the customers for each of the customer segments, wherein the time-series relationship of the renovation works is time-series relationship between at least two renovation works; and
outputting an analysis result.
